(19) United States
(12) Patent Application Publication
(10) Pub. No.: US 2019/0244523 A1
(43) Pub. Date: Aug. 8, 2019

(54) INFORMATION PROVIDING DEVICE AND TERMINAL DEVICE

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/269,089

(22) Filed: Feb. 6, 2019

(30) Foreign Application Priority Data
Feb. 8, 2018 (JP) 2018-020689

(51) Int. Cl. G08G 1/127; G07B 15/06; G07B 15/02; G06Q 30/02; G06Q 30/06

(52) U.S. Cl. CPC G08G 1/127; G07B 15/06; G06Q 30/0645; G06Q 30/0207; G07B 15/02

(57) ABSTRACT

An information providing device includes an acquisition unit that acquires return position information indicating a position to which a vehicle is returned and first user position information indicating a position of a first user who is scheduled to move to a facility, a selection unit that selects a first vehicle for which the return position information and the first user position information satisfy a predetermined relationship, and a transmission unit that transmits the return position information of the first vehicle to the first user. A terminal device includes an output unit that receives and outputs return position information, which indicates a position to which a vehicle is returned, of a first vehicle satisfying a predetermined relationship with first user position information indicating a position of a first user who is scheduled to move to a facility.

### CROSS-REFERENCE TO RELATED APPLICATION

This application claims priority to Japanese Patent Application No. 2018-020689 filed on Feb. 8, 2018, incorporated herein by reference in its entirety.

### BACKGROUND

### 1. Technical Field

The disclosure relates to an information providing device and a terminal device.

### 2. Description of Related Art

Japanese Unexamined Patent Application Publication No. 2010-170283 (JP 2010-170283 A) discloses a carport management system including a movement target carport selecting means that selects a source carport and a destination carport in movement of a vehicle, a time limiting setting means that sets a time limit at the time of movement of the vehicle, a movement request notifying means that notifies a user of a movement request of the vehicle, a checking means that checks whether the vehicle has moved to the destination carport, and a payment means that performs payment of a predetermined incentive for the user when the checking means checks that the vehicle has moved.

### SUMMARY

However, such a carport management system has a problem in that a user cannot cope with a movement request when a time required for the user to arrive at a destination carport is long and a problem with uneven distribution of vehicles in carports cannot be resolved in some cases.

Therefore, the disclosure provides an information providing device and a terminal device that can reduce labor of a user who moves a carsharing vehicle and relax uneven distribution of vehicles.

According to a first aspect of the disclosure, there is provided an information providing device including: an acquisition unit configured to acquire return position information indicating a position to which a vehicle is returned and first user position information indicating a position of a first user who is scheduled to move to a facility; a selection unit configured to select a first vehicle for which the return position information and the first user position information satisfy a predetermined relationship; and a transmission unit configured to transmit the return position information of the first vehicle to the first user.

In the first aspect of the disclosure, the selection unit may be configured to select the first vehicle for which a time required for the first user to arrive at the vehicle is equal to or less than a predetermined time based on the return position information and the first user position information.

In the first aspect of the disclosure, the selection unit may be configured to select the first vehicle for which a length of a route which is used for the first user to arrive at the vehicle is equal to or less than a predetermined length based on the return position information and the first user position information.

The information providing device according to the first aspect of the disclosure may further include a reception unit configured to receive use completion information indicating that the first user has moved to the facility using the first vehicle. The transmission unit may be configured to additionally transmit incentive information indicating details of an incentive which is to be given based on use of the first vehicle when the reception unit has received the use completion information.

The information providing device according to the first aspect of the disclosure may further include a reception unit configured to receive nonuse information indicating that the first vehicle is not used. The selection unit may be configured to select a first vehicle other than the first vehicle that is previously selected when the reception unit has received the nonuse information.

According to a second aspect of the disclosure, there is provided a terminal device including an output unit configured to receive and output return position information of a first vehicle satisfying a predetermined relationship with first user position information indicating a position of a first user who is scheduled to move to a facility out of return position information indicating positions to which vehicles are returned.

In the second aspect of the disclosure, the output unit may be configured to select the return position information of a first vehicle for which a time required for the first user to arrive at the vehicle is equal to or less than a predetermined time out of the return position information indicating positions to which vehicles are returned.

In the second aspect of the disclosure, the output unit may be configured to receive and output the return position information of the first vehicle for which a length of a route which is used for the first user to arrive at one of the vehicles is equal to or less than a predetermined length out of the return position information indicating positions to which the vehicles are returned.

The terminal device according to the second aspect of the disclosure may further include a transmission unit configured to transmit use completion information indicating that the first user has moved to the facility using the first vehicle. The output unit may be configured to additionally output incentive information indicating details of an incentive which is to be given based on use of the first vehicle.

The terminal device according to the second aspect of the disclosure may further include a transmission unit configured to transmit nonuse information indicating that the first vehicle is not used. The output unit may be configured to receive and output the return position information of a first vehicle other than the first vehicle that is previously selected.

According to the disclosure, it is possible to provide an information providing device and a terminal device that can reduce labor of a user who moves a carsharing vehicle and relax uneven distribution of vehicles.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of an information providing device and a terminal device according to an embodiment;

FIG. 2 is a sequence diagram illustrating an example of a routine which is performed by the information providing device and the terminal device according to the embodiment; and

FIG. 3 is a sequence diagram illustrating an example of a routine which is performed by the information providing device and the terminal device according to the embodiment.

### DETAILED DESCRIPTION

Hereinafter, an exemplary embodiment of the disclosure will be described with reference to the accompanying drawings. In the drawings, elements referred to by the same reference signs are the same as each other or have the same configuration.

### Embodiment

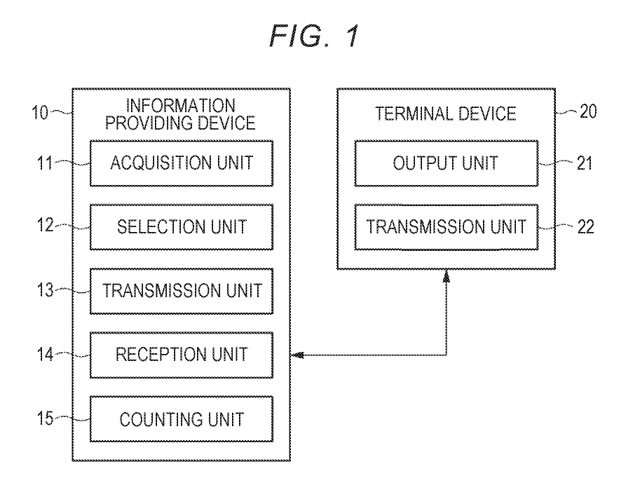

A configuration of an information providing device according to an embodiment will be described below with reference to FIG. 1.

An information providing device 10 is, for example, a server that is used to provide a carsharing service and includes an acquisition unit 11, a selection unit 12, a transmission unit 13, a reception unit 14, and a counting unit 15 as illustrated in FIG. 1. The information providing device 10 has only to include at least the acquisition unit 11, the selection unit 12, and the transmission unit 13, and may use another device having functions equivalent to the acquisition unit 11, the selection unit 12, the transmission unit 13, the reception unit 14, and the counting unit 15. The information providing device 10 may be divided into a server that is owned by a provider who provides a carsharing service and a server that is installed in a commercial facility or the like, and the respective elements may be included in any one server.

A terminal device 20 is, for example, a smartphone which is carried by a user who uses a carsharing service and includes an output unit 21 and a transmission unit 22 as illustrated in FIG. 1. The terminal device 20 may employ another device having functions equivalent to the output unit 21 and the transmission unit 22.

The information providing device 10 and the terminal device 20 may have an element other than the elements illustrated in FIG. 1.

The acquisition unit 11 acquires return position information indicating a position to which a vehicle is returned and first user position information indicating a position of a first user who is scheduled to move to a facility. A facility which is mentioned herein is, for example, a commercial facility. A first user is, for example, an employee of a facility and an intention indicating that the first user is scheduled to go to the facility is registered in advance. The return position information is acquired, for example, from a Global Positioning System (GPS) receiver which is mounted in a vehicle. The first user position information is acquired, for example, from a GPS receiver which is mounted in the terminal device 20 carried by the first user.

The selection unit 12 selects a first vehicle for which the return position information and the first user position information satisfy a predetermined relationship.

Specifically, the selection unit 12 selects a first vehicle for which a time required for the first user to arrive at the vehicle is equal to or less than a predetermined time based on the return position information and the first user position information. For example, the selection unit 12 calculates the time from a length of a route until the first user arrives at the vehicle and a speed of a general walker and selects a vehicle for which the time is equal to or less than the predetermined time as the first vehicle.

Alternatively, the selection unit 12 selects a first vehicle for which a length of a route used for the first user to arrive at the vehicle is equal to or less than a predetermined length based on the return position information and the first user position information. For example, the selection unit 12 estimates a route connecting a return position of the first vehicle to the position of the first user from the return position information and the first user position information, calculates the length of the route, and selects a vehicle for which the length is equal to or less than a predetermined length as the first vehicle.

The transmission unit 13 transmits the return position information of the first vehicle to the first user.

The reception unit 14 receives use completion information indicating that the first user has moved to the facility using the first vehicle. When the reception unit 14 receives the use completion information, the transmission unit 13 transmits incentive information indicating details of an incentive which is given based on use of the first vehicle. As an incentive which is mentioned herein, for example, a value corresponding to one yen is set for one point, and these points can be used in a predetermined commercial facility.

The reception unit 14 receives use information indicating that the first vehicle is used or nonuse information indicating that the first vehicle is not used. When the reception unit 14 receives the nonuse information, the selection unit 12 selects a first vehicle other than the previously selected first vehicle. The transmission unit 13 transmits return position information of the other first vehicle to the first user.

The acquisition unit 11 may acquire facility position information indicating a position of the facility. In this case, the counting unit 15 counts the number of second vehicles for which a time required for a second user who is scheduled to move from the facility to arrive at the vehicle is equal to or less than a predetermined time based on the return position information and the facility position information. Here, a second user is, for example, an employee of the facility and an intention indicating that the second user is scheduled to leave the facility is registered in advance. When the number counted by the counting unit 15 is equal to or less than a predetermined number, the transmission unit 13 transmits nonuse encouragement information for encouraging that the second vehicle not be used for movement from the facility.

The output unit 21 is, for example, a display of a smartphone which is carried by a user who uses a carsharing service. The output unit 21 receives and outputs return position information of a first vehicle which satisfies a predetermined relationship with first user position information indicating a position of the first user who is scheduled to move to a facility out of return position information indicating positions to which vehicles are returned. Specifically, the output unit 21 receives and outputs return position information of a first vehicle for which a time required for the first user, who is scheduled to move to the facility, to arrive at the vehicle is equal to or less than a predetermined time out of return position information indicating positions to which vehicles are returned. Alternatively, the output unit 21 receives and outputs return position information of a first vehicle for which a length of a route which is used for the first user, who is scheduled to move to the facility, to arrive at the vehicle is equal to or less than a predetermined length out of return position information indicating positions to which vehicles are returned.

The transmission unit 22 determines whether the first vehicle of which the return position information has been transmitted by the transmission unit 13 is to be used. This determination is performed, for example, based on information input via a human-machine interface (HMI) of a smartphone.

The transmission unit 22 transmits use completion information indicating that the first user has moved to the facility using the first vehicle. The output unit 21 receives and outputs incentive information indicating details of an incentive which is given based on use of the first vehicle.

The transmission unit 22 transmits use information indicating that the first vehicle is used or nonuse information indicating that the first vehicle is not used. The output unit 21 receives and outputs return position information of a first vehicle other than the previously selected first vehicle.

Use information, nonuse information, and use completion information are input, for example, via a human-machine interface of a smartphone.

When the acquisition unit 11 acquires facility position information, the output unit 21 may receive nonuse encouragement information for encouraging that a second vehicle, for which a time required for a second user, who is scheduled to move from the facility, to arrive at the vehicle is equal to or less than a predetermined time, not be used for movement from the facility from the transmission unit 13 of the information providing device 10 and output the received nonuse encouragement information.

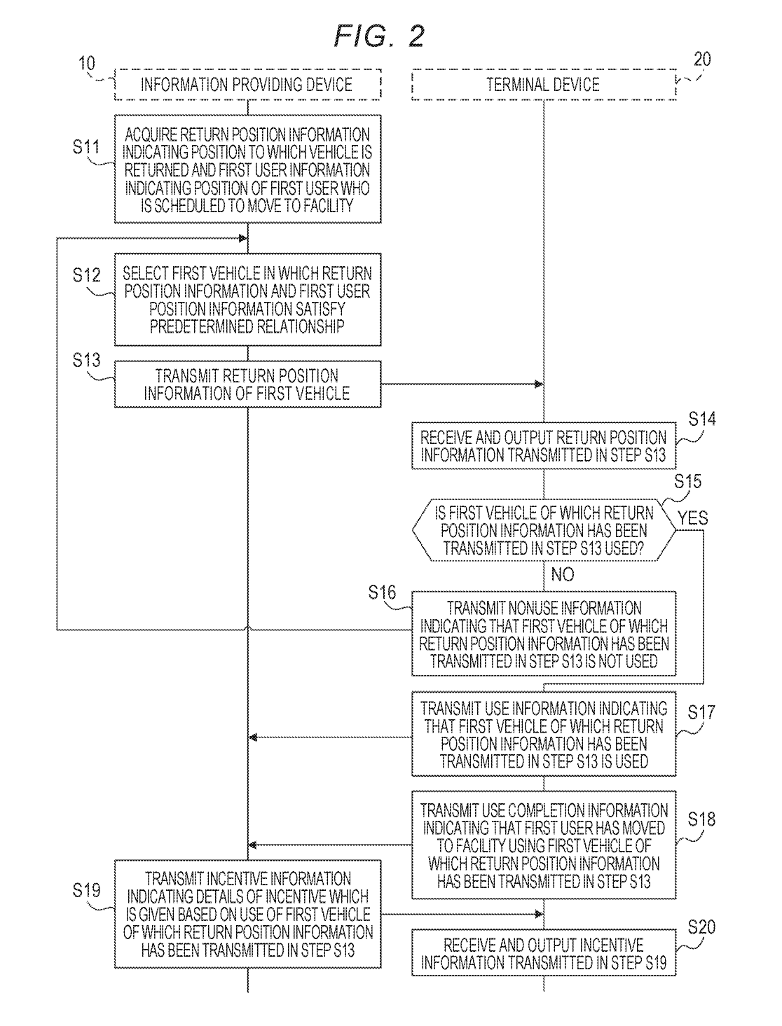

An example of an exemplary routine which is performed by the information providing device 10 and the terminal device 20 according to the embodiment will be described below with reference to FIG. 2.

In Step S11, the acquisition unit 11 acquires return position information indicating a position to which a vehicle is returned and first user information indicating a position of a first user who is scheduled to move to a facility. Step S 11 may be performed in real time or may be performed at predetermined time intervals.

In Step S12, the selection unit 12 selects a first vehicle of which the return position information satisfies a predetermined relationship with the first user information. When Step S12 is performed immediately after Step S16, the selection unit 12 selects a first vehicle other than the previously selected first vehicle. In some embodiments, Step S12 is performed at predetermined time intervals.

In Step S13, the transmission unit 13 transmits the return position information of the first vehicle.

In Step S14, the output unit 21 receives and outputs the return position information transmitted in Step S13.

In Step S15, the transmission unit 22 determines whether the first vehicle of which the return position information has been transmitted in Step S13 is to be used. The transmission unit 22 causes the routine to transition to Step S16 when it is determined that the first vehicle is not to be used (Step S15: NO), and causes the routine to transition to Step S17 when it is determined that the first vehicle is to be used (Step S15: YES).

In Step S16, the transmission unit 22 transmits nonuse information indicating that the first vehicle of which the return position information has been transmitted in Step S13 is not to be used. Thereafter, the reception unit 14 returns the routine to Step S12.

In Step S17, the transmission unit 22 transmits use information indicating that the first vehicle of which the return position information has been transmitted in Step S13 is to be used. Thereafter, the transmission unit 22 causes the routine to transition to Step S18.

Step S17 is performed when the first user who has referred to the return position information output in Step S14 desires to use the first vehicle of which the return position information has been transmitted in Step S13, and Step S16 is performed when the first user does not desire to use the first vehicle.

In Step S18, the transmission unit 22 transmits use completion information indicating that the first user has moved to the facility using the first vehicle of which the return position information has been transmitted in Step S13.

In Step S19, the transmission unit 13 transmits incentive information indicating details of an incentive which is given based on use of the first vehicle of which the return position information has been transmitted in Step S13.

In Step S20, the output unit 21 receives and outputs the incentive information transmitted in Step S19.

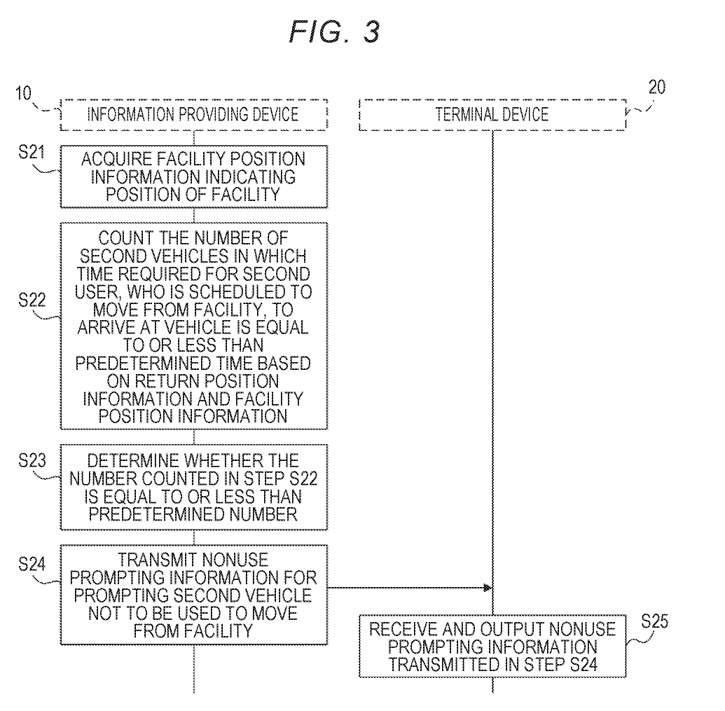

An example of an exemplary routine which is performed by the information providing device 10 and the terminal device 20 according to the embodiment will be described below with reference to FIG. 3.

In Step S21, the acquisition unit 11 acquires facility position information indicating a position of a facility.

In Step S22, the counting unit 15 counts the number of second vehicles for which a time required for a second user, who is scheduled to move from the facility, to arrive at the vehicle is equal to or less than a predetermined time based on the return position information and the facility position information.

In Step S23, the transmission unit 13 determines whether the number counted in Step S22 is equal to or less than a predetermined number. The transmission unit 13 causes the routine to transition to Step S24 when the counted number is equal to or less than the predetermined number, and ends the routine when the counted number is greater than the predetermined number.

In Step S24, the transmission unit 13 transmits nonuse encouragement information for encouraging that the second vehicle not be used for movement from the facility.

In Step S25, the output unit 21 receives and outputs the nonuse encouragement information transmitted in Step S24.

An embodiment of the disclosure has been described hitherto. The information providing device 10 according to the embodiment selects a first vehicle for which return position information and first user position information satisfy a predetermined relationship and transmits the return position information of the first vehicle to a first user. The terminal device 20 according to the embodiment receives and outputs the return position information of the first vehicle. Accordingly, the information providing device 10 and the terminal device 20 can reduce labor required for the first user to arrive at the vehicle and encourage the first user to move the first vehicle to the facility.

When use completion information indicating that the first user has moved to the facility using the first vehicle is received, the information providing device 10 transmits incentive information indicating details of an incentive which is given based on use of the first vehicle. The terminal device 20 receives and outputs the incentive information. Accordingly, the information providing device 10 and the terminal device 20 can reward the first user who arrives at the vehicle and moves the vehicle to the facility with an incentive and more strongly encourage the first user to move the first vehicle to the facility.

When nonuse information indicating that the first vehicle is not used is received, the information providing device 10 selects a first vehicle other than the previously selected first vehicle and transmits return position information of the other first vehicle to the first user. The terminal device 20 transmits nonuse information and receives and outputs the return position information of the other first vehicle. Accordingly, the information providing device 10 and the terminal device 20 can present another first vehicle instead of the first vehicle which is determined not to be used by the first user and encourage the first user to move the first vehicle to the facility.

The information providing device 10 counts the number of second vehicles for which a time required for a second user, who is scheduled to move from the facility, to arrive at the vehicle is equal to or less than a predetermined time based on the return position information and the facility position information, and transmits nonuse encouragement information for encouraging that a second vehicle not be used for movement from the facility. The terminal device 20 receives and outputs the nonuse encouragement information. Accordingly, the information providing device 10 and the terminal device 20 can prevent the number of second vehicles located in the facility or in the vicinity thereof from becoming insufficient by allowing a second user who is scheduled to move from the facility to use a carsharing vehicle located in the facility or the vicinity thereof.

The disclosure is not limited to the above-mentioned embodiment and can be modified in various forms without departing from the gist of the disclosure. Accordingly, the above-mentioned embodiment is merely exemplary in all respects and is not to be construed as restrictive. For example, the steps of the routines may be performed in an arbitrarily changed order or in parallel as long as the process details do not cause inconsistency.

What is claimed is:

1. An information providing device comprising:
an acquisition unit configured to acquire return position information indicating a position to which a vehicle is returned and first user position information indicating a position of a first user who is scheduled to move to a facility;
a selection unit configured to select a first vehicle for which the return position information and the first user position information satisfy a predetermined relationship; and
a transmission unit configured to transmit the return position information of the first vehicle to the first user.

2. The information providing device according to claim 1, wherein the selection unit is configured to select the first vehicle for which a time required for the first user to arrive at the vehicle is equal to or less than a predetermined time based on the return position information and the first user position information.

3. The information providing device according to claim 1, wherein the selection unit is configured to select the first vehicle for which a length of a route which is used for the first user to arrive at the vehicle is equal to or less than a predetermined length based on the return position information and the first user position information.

4. The information providing device according to claim 1, further comprising a reception unit configured to receive use completion information indicating that the first user has moved to the facility using the first vehicle,
wherein the transmission unit is configured to additionally transmit incentive information indicating details of an incentive which is to be given based on use of the first vehicle when the reception unit has received the use completion information.

5. The information providing device according to claim 1, further comprising a reception unit configured to receive nonuse information indicating that the first vehicle is not used,
wherein the selection unit is configured to select a first vehicle other than the first vehicle that is previously selected when the reception unit has received the nonuse information.

6. A terminal device comprising:
an output unit configured to receive and output return position information of a first vehicle satisfying a predetermined relationship with first user position information indicating a position of a first user who is scheduled to move to a facility out of return position information indicating positions to which vehicles are returned.

7. The terminal device according to claim 6, wherein the output unit is configured to select the return position information of the first vehicle for which a time required for the first user to arrive at the vehicle is equal to or less than a predetermined time out of the return position information indicating positions to which the vehicles are returned.

8. The terminal device according to claim 6, wherein the output unit is configured to receive and output the return position information of the first vehicle for which a length of a route which is used for the first user to arrive at one of the vehicles is equal to or less than a predetermined length out of the return position information indicating positions to which the vehicles are returned.

9. The terminal device according to claim 6, further comprising a transmission unit configured to transmit use completion information indicating that the first user has moved to the facility using the first vehicle,
wherein the output unit is configured to additionally output incentive information indicating details of an incentive which is to be given based on use of the first vehicle.

10. The terminal device according to claim 6, further comprising a transmission unit configured to transmit nonuse information indicating that the first vehicle is not used,
wherein the output unit is configured to receive and output the return position information of a first vehicle other than the first vehicle that previously selected.
